(19) United States
(12) Patent Application Publication
(10) Pub. No.: US 2024/0060395 A1
(43) Pub. Date: Feb. 22, 2024

(54) RETRIEVABLE GUIDE FUNNEL AND CONNECTION SYSTEM UTILIZING THE SAME

(71) Applicants: Stanley Hosie, Katy, TX (US); Lee Hosie, Katy, TX (US)

(72) Inventors: Stanley Hosie, Katy, TX (US); Lee Hosie, Katy, TX (US)

(21) Appl. No.: 18/236,881

(22) Filed: Aug. 22, 2023

Related U.S. Application Data
(60) Provisional application No. 63/400,028, filed on Aug. 22, 2022.

(51) Int. Cl. E21B 41/00

(52) U.S. Cl. CPC E21B 41/0014

(57) ABSTRACT

A device for facilitating the connection of fluid pipes, particularly for subsea oils and gas equipment. The device has a funnel shaped opening at the top and bottom and a cavity therebetween for holding a hub clamp. The funnel shaped openings facilitate alignment and insertion of pipes, caps, etc. to be connected by the hub clamp. The device may be installed or removed in subsea environments without raising other equipment.

### CROSS-REFERENCE TO RELATED APPLICATION

This application claims priority to U.S. Provisional Application No. 63/400,028, which was filed on Aug. 22, 2022, which is incorporated by reference herein in its entirety.

### FIELD OF THE INVENTION

This disclosure relates generally to pipelines. More specifically, it relates to underwater fluid pipelines. Even more specifically, it relates to a device for facilitating connection of underwater fluid pipelines and a system utilizing the device.

### BACKGROUND

Undersea pipelines present many difficulties compared to pipelines on land. Access to the equipment and pipes is hampered by the distances and conditions at depth. Some of the deepest pipelines are only accessible by unmanned Remotely Operated Vehicles (ROVs). Connecting equipment is therefore cumbersome and expensive.

Existing connection systems, such as those described in U.S. Pat. No. 10,787,863 are designed to facilitate a connection between a substantially vertical pipe of a subsea structure and a jumper pipe. These existing designs use a so-called female-like coupling member which has a guide funnel and clamp that is attached to the jumper pipe, cap, or other object to be connected. Because the coupling member is permanently or semi-permanently attached, each jumper pipe, cap, etc. needs to have its own coupling member. Additionally, if the clamp is damaged or needs to be replaced, the entire jumper pipe needs to be raised to the surface at significant financial and time cost.

It would therefore be advantageous to have a device which avoids these and other drawbacks of existing methods and devices.

### SUMMARY OF THE INVENTION

A retrievable guide funnel according to embodiments comprises an upper guide portion comprising a first funnel, a hub clamp portion comprising a frame connected to the upper guide portion, the frame having a cavity for accepting a hub clamp therein, and a lower guide portion connected to the frame of the hub clamp portion, the lower guide portion comprising a lower guide receiver section connected to the frame. The upper guide portion may also include an upper receiver section connected to the first funnel, a second funnel connected to the upper receiver section, and a lower receiver section connected to the second funnel. The lower guide portion may also include a lower guide funnel connected to the receiver section, and a locking pin for securing the retrievable guide funnel. The hub clamp portion may further comprise an ROV bucket for facilitating clamping.

A subsea connection system using a retrievable guide funnel according to embodiments may include a retrievable guide funnel, vertical pipe arrangement, hub clamp, and a jumper pipe or cap. The jumper pipe or cap may include a guide cone or guide fin for facilitating insertion of the jumper pipe or cap into the guide funnel.

### BRIEF DESCRIPTION OF THE DRAWINGS

FIG. 1 depicts a section view of a vertical pipe arrangement attached to a subsea structure according to an embodiment.

FIG. 2 depicts a section view of a jumper pipe end portion according to an embodiment.

FIG. 3 depicts a partial section view of a retrievable guide funnel 300 according to one embodiment.

FIG. 4 depicts a section view of a pressure cap according to one embodiment.

### DETAILED DESCRIPTION

Subsea pipelines pose significant challenges in connecting equipment. Current systems require a plurality of connection devices and often require components to be raised to the surface for repair or service. To that end, an improved system for connecting subsea equipment is disclosed herein.

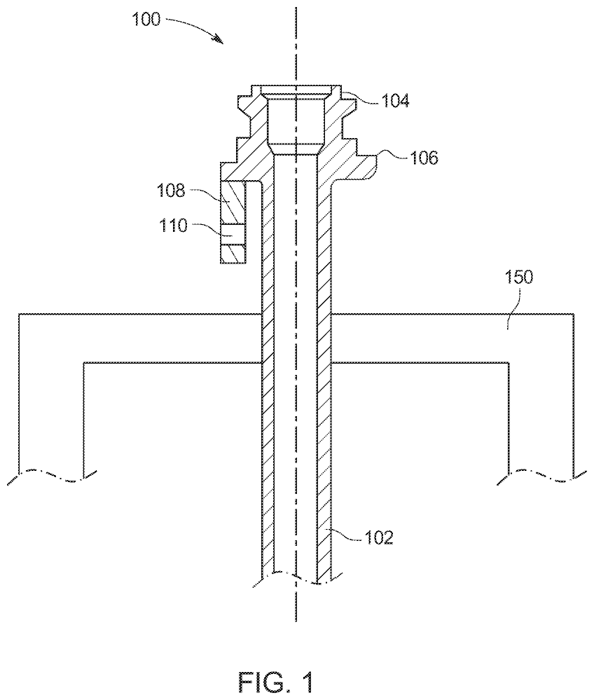

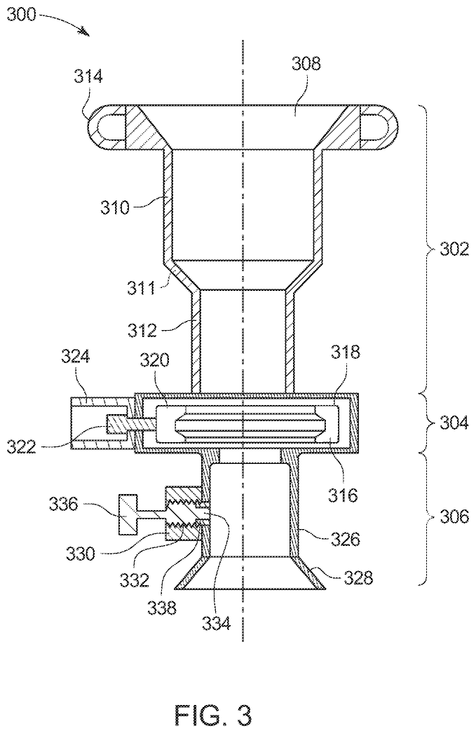

FIG. 1 depicts a section view of a vertical pipe arrangement 100 attached to a subsea structure 150 according to an embodiment. The vertical pipe is comprised of a tubular member 102 which is used for conveying fluids. At the upper end of the tubular member 102 is a hub 104 for facilitating a connection to other equipment such as pipes or caps. Below hub 104 is landing shoulder 106 which extends around the outer circumference of the tubular member and is used to vertically locate a retrievable guide funnel which will be described later with respect to FIG. 3.

Extending downward from landing shoulder 106 is an arm 108. Arm 108 comprises a receptacle 110 for receiving a locking pin of a retrievable guide funnel. Receptacle 110 may comprise a through hole and may be threaded, tapered, etc.

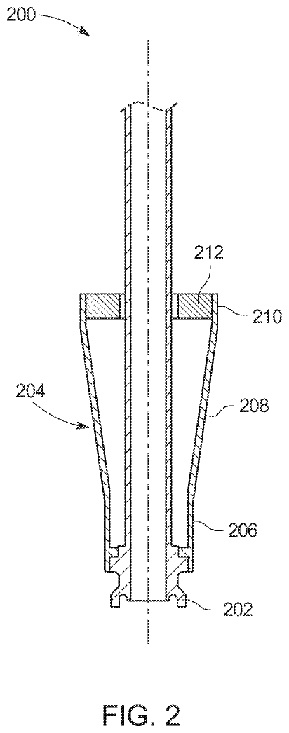

FIG. 2 depicts a section view of a jumper pipe end portion according to an embodiment. Jumper pipe 200 comprises a tubular member for conveying fluids. Jumper pipe 200 is designed to be removably attached to equipment such as the vertical pipe arrangement from FIG. 1. Jumper pipe 200 has a hub 202 attached to a lower end of the tubular member. Hub 202 is designed to interface with hub 104 as is typical for subsea fluid systems. Jumper pipe 200 differs from conventional designs in that jumper pipe 200 has a guide cone 204 affixed to the jumper pipe near the hub 202 at the end of the pipe.

Guide cone 204 has a generally cylindrical shape, with some sections having a conical shape. Near the hub 202, guide cone 204 has a lower guide section 206 which is cylindrical in shape. Lower guide section 206 may be sized to fit around hub 202 and may be attached to hub 202 or the tubular member.

Above the lower guide section is a conical section 208 which connects the lower guide section 206 to the upper guide section 210. Upper guide section 210 is cylindrical in shape and has a larger diameter that lower guide section 206. Conical section 208 provides a gradual transition of diameter between the lower guide section 206 and the upper guide section 210. Upper guide section 210 is connected to the tubular member via supports 212 to provide angular and axial alignment of the guide cone 204 on the tubular member.

FIG. 3 depicts a partial section view of a retrievable guide funnel 300 according to one embodiment. Retrievable guide funnel 300 is designed to facilitate connections between equipment, such as vertical pipe arrangement 100 from FIG. 1 and jumper pipe 200 from FIG. 2. Retrievable guide funnel 300 comprises an upper guide portion 302, a hub clamp portion 304, and a lower guide portion 306.

Upper guide portion 302 is a generally cylindrical section used to guide a device such as jumper pipe 200 into location. Upper guide portion 302 is designed to interface with guide cone 204 and is designed to prevent binding during assembly. Upper guide portion 302 comprises a first funnel 308 which guides jumper pipe 200 into the upper receiver section 310. Below upper receiver section 310 is a second funnel 311 which provides a gradual transition from upper receiver section 310 and lower receiver section 312. Attached to the outer surface of first funnel 308 are a plurality of lifting eyes 314 which comprise an opening for attaching to a cable for installing, retrieving, or moving the guide funnel.

Hub clamp portion 304 is designed to hold a hub clamp 316 in the proper location for attaching to one or more hubs. Hub clamp portion comprises a frame 318 attached to upper guide portion 302 and lower guide portion 306. Frame 318 has openings on the top and bottom to allow hubs, pipes, and other devices to pass through the guide portions and into the hub clamp portion. Frame 318 also has a cavity 320 designed to receive hub clamp 316 and locate the hub clamp 316 in the proper location for clamping hubs. The hub clamp 316 is clamped and unclamped by a screw 322 accessible within an ROV bucket 324. The ROV bucket 324 is designed to accept a tool from an ROV and to facilitate clamping and unclamping of the hub clamp 316.

Lower guide portion 306 is designed to guide the funnel 300 onto a vertical pipe arrangement, such as that shown in FIG. 1. Lower guide portion 306 comprises a roughly cylindrical section comprised of a receiver section 326 and a funnel 328 attached to a lower end of the receiver section 326. Funnel 328 helps guide the funnel 300 onto the vertical pipe as the funnel is lowered onto the vertical pipe. Receiving section 326 receives the hub 104, landing shoulder 106, and arm 108. Landing shoulder 106 is designed to rest at the top edge of receiving section 326 such that hub 104 extends through frame 318 and positions the hub 104 at the proper location within the hub clamp 316.

Lower guide portion 306 also includes an ROV locking pin 330 for attaching and locating retrievable guide funnel 300 to vertical pipe arrangement 100. ROV locking pin 330 is comprised of a shaft having an externally threaded section 332, an unthreaded section 334, and a head 336. ROV locking pin 330 is held within threaded hole 338 in the lower guide portion 306. ROV locking pin 330 interfaces with receptacle 110 to secure and locate retrievable guide funnel 300 onto vertical pipe arrangement 100.

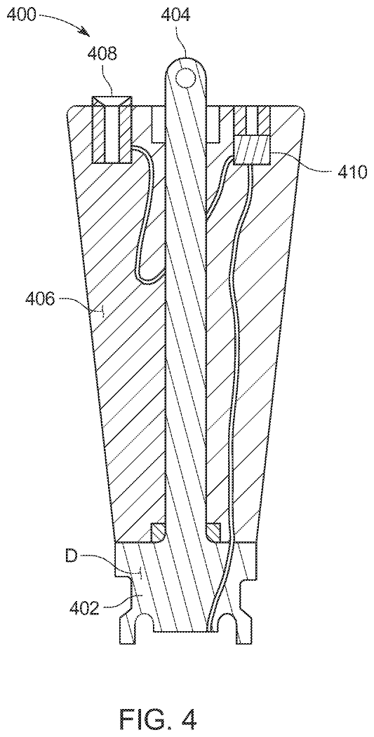

Turning now to FIG. 4, a section view of a pressure cap according to one embodiment is shown. Pressure cap 400 is designed to be removably attached to equipment such as vertical pipe arrangement 100 for the purpose of blocking off tubular member 102 to prevent undesired inflows and outflows. At the lower end of pressure cap 400 is blind hub 402. Blind hub 402 is designed to interface with hub 104 as is typical for subsea fluid systems. Blind hub 402 may be attached to vertical pipe arrangement 100 via hub clamp 316 of retrievable guide funnel 300.

At the opposite end of pressure cap 400 (from blind hub 402) is a lift eye 404 which has an opening designed to receive a cable or other device for the purpose of moving the pressure cap 400. Extending upward from blind hub 402 is one or more guide fins 406. Guide fin 406 may be a flat plate and may increase in width from blind hub 402 (also known as a pressure cap hub) toward lift eye 404 or may otherwise be shaped to facilitate insertion into upper guide portion 302 of retrievable guide funnel 300.

Near the top of pressure cap 400 is an ROV hot stab 408 and isolation valve 410, both of which may be attached to guide fin 406. The hot stab 408 allows the connection between hub 104 and blind hub 402 to be tested on the surface and, once subsea, to check for trapped pressure below the pressure cap and bleed off the pressure if necessary to reduce the chance of blowout and hydrocarbon spillage.

In operation, the retrievable guide funnel 300 operates with vertical pipe arrangement 100, pressure cap 400, and jumper pipe 200 as follows. Installation of the retrievable guide funnel 300 and pressure cap 400 may be performed before the subsea structure is lowered to the seabed or the retrievable guide funnel may be installed underwater. In the following example, a pressure cap will be attached to a vertical pipe arrangement using a retrievable guide funnel before lowering the assembly into the sea.

Using a cable connected to lifting eyes 314, the retrievable guide funnel 300 is lowered onto the vertical pipe arrangement 100. Funnel 328 guides the retrievable guide funnel 300 onto hub 104 and the retrievable guide funnel 300 is lowered until the landing shoulder 106 is in contact with the receiver section 326. Retrievable guide funnel 300 may be turned if needed to align ROV locking pin 330 with receptacle 110. A tool may be used to turn head 336, causing the ROV locking pin to thread inward toward the receptacle 110 until unthreaded section 334 is inside receptacle 110. The ROV locking pin prevents axial and rotational movement of the retrievable guide funnel 300 with respect to the vertical pipe arrangement 100.

With the retrievable guide funnel 300 installed onto the vertical pipe arrangement 100, pressure cap 400 may be installed. Pressure cap 400 is lowered into upper guide portion 302 by a cable connected to lift eye 404. When blind hub 402 is seated onto hub 104, hub clamp 316 may be tightened to secure the pressure cap and seal the tubular member 102. The subsea structure 150 comprising vertical pipe arrangement 100 with attached retrievable guide funnel 300 and pressure cap 400 may then be lowered into the water to the seabed.

Once the subsea structure is on the seabed, jumper pipe 200 may be connected at a desired time. To connect jumper pipe 200, pressure cap 400 is first removed as follows. Hub clamp 316 is unclamped and the pressure cap 400 is lifted off hub 104 via lift eye 404. Pressure cap 400 may be lifted off by ROV or by the surface installation vessel.

With the pressure cap 400 removed, hub 202 of jumper pipe 200 may be lowered into upper guide portion 302 starting with first funnel 308. Jumper pipe 200 may be progressively lowered until hub 202 is in contact with hub 104. At this time, lower guide section 206 is within lower receiver section 312 while upper guide section 210 is within upper receiver section 310. Guide cone 204 and upper guide portion 302 hold the jumper pipe 200 in collinear alignment with vertical pipe arrangement 100. With the jumper pipe 200 collinearly aligned with the vertical pipe arrangement, hub 202 in contact with hub 104, and hub clamp 316 aligned with hub 202 and hub 104, the ROV may then tighten the screw 322 of hub clamp 316 to tighten the hub clamp 316 onto the hubs 202 and 104 to create a secure connection.

To disconnect the jumper pipe 200, the ROV loosens the hub clamp 316 via the screw 322. The jumper pipe may then be lifted out of the retrievable guide funnel 300. Because the guide funnel attaches to the vertical pipe arrangement 100 and not the jumper pipe 200, only one retrievable guide funnel and hub clamp is needed for the vertical pipe arrangement. Existing systems require a hub clamp for each device that could connect to the vertical pipe arrangement, thus increasing the cost and complexity of the system. Additionally, if the hub clamp is damaged, the entire jumper pipe need not be lifted to the surface. A replacement hub clamp may be provided in a second retrievable guide funnel. The first guide funnel with damaged clamp may be removed and brought to the surface. The second retrievable guide funnel may be lowered from the surface installation vessel and installed. The first guide funnel may be refitted with a new clamp at the surface and reused as needed. The time, cost, and complexity of repairing a damaged hub clamp is therefore significantly reduced.

It is contemplated that such a retrievable guide funnel and system could take many forms without departing from the spirit of the invention.

The discussion herein of the present invention is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Herein, the terms “including,” “consisting of”, and “comprising” are used in an open-ended fashion, and thus should be interpreted to mean “including, but not limited to.” Also, the term “connect” or “connected” where used if at all is intended to mean either an indirect or direct connection. Thus, if a first component connects to a second component, that connection may be through a direct connection or through an indirect connection via other components and connections.

The term “or” is used in the inclusive manner. For example, “A or B” could mean A only, B only, or both A and B.

Certain terms are used throughout the description and claims to refer to particular system components and method steps. As one skilled in the art will appreciate, different companies may refer to a component by different names. This document does not intend to distinguish between components that differ in name but not function.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A retrievable guide funnel, comprising:
an upper guide portion, comprising:
a first funnel,
a hub clamp portion, comprising:
a frame connected to the upper guide portion, the frame having a cavity for accepting a hub clamp therein; and
a lower guide portion connected to the frame of the hub clamp portion, comprising:
a lower guide receiver section connected to the frame.

2. The retrievable guide funnel of claim 1, wherein the upper guide portion further comprises:
an upper receiver section connected to the first funnel,
a second funnel connected to the upper receiver section, and
a lower receiver section connected to the second funnel.

3. The retrievable guide funnel of claim 1, wherein the lower guide portion further comprises:
a lower guide funnel connected to the receiver section, and
a locking pin for securing the retrievable guide funnel.

4. The retrievable guide funnel of claim 1, wherein the upper guide portion further comprises:
an upper receiver section connected to the first funnel,
a second funnel connected to the upper receiver section, and
a lower receiver section connected to the second funnel; and
wherein the lower guide portion further comprises:
a lower guide funnel connected to the receiver section, and
a locking pin for securing the retrievable guide funnel.

5. The retrievable guide funnel of claim 4, wherein the hub clamp portion further comprises:
an ROV bucket for facilitating clamping.

6. A subsea pipe connection system using a retrievable guide funnel, comprising:
a vertical pipe arrangement, and
a retrievable guide funnel connected to the vertical pipe arrangement, the retrievable guide funnel comprising:
an upper guide portion, comprising:
a first funnel,
a hub clamp portion, comprising:
a frame connected to the upper guide portion, the frame having a cavity for accepting a hub clamp therein; and
a lower guide portion connected to the frame of the hub clamp portion, comprising:
a lower guide receiver section connected to the frame.

7. The subsea pipe connection system using a retrievable guide funnel of claim 6, wherein the upper guide portion further comprises:
an upper receiver section connected to the first funnel,
a second funnel connected to the upper receiver section, and
a lower receiver section connected to the second funnel.

8. The subsea pipe connection system using a retrievable guide funnel of claim 6, wherein the lower guide portion further comprises:
a lower guide funnel connected to the receiver section, and
a locking pin for securing the retrievable guide funnel.

9. The subsea pipe connection system using a retrievable guide funnel of claim 6, wherein the upper guide portion further comprises:
an upper receiver section connected to the first funnel,
a second funnel connected to the upper receiver section, and
a lower receiver section connected to the second funnel; and
wherein the lower guide portion further comprises:
a lower guide funnel connected to the receiver section, and
a locking pin for securing the retrievable guide funnel.

10. The subsea pipe connection system using a retrievable guide funnel of claim 9, wherein the hub clamp portion further comprises:
an ROV bucket for facilitating clamping.

11. A subsea pipe connection system using a retrievable guide funnel, comprising:
a vertical pipe arrangement,
a retrievable guide funnel connected to the vertical pipe arrangement, the retrievable guide funnel comprising:
an upper guide portion, comprising:
a first funnel,
a hub clamp portion, comprising:
a frame connected to the upper guide portion, the frame having a cavity for accepting a hub clamp therein; and
a lower guide portion connected to the frame of the hub clamp portion, comprising:
a lower guide receiver section connected to the frame;
a jumper pipe or a cap, the jumper pipe or the cap having a guide cone or a guide fin attached, the guide cone or the guide fin designed to facilitate insertion into the retrievable guide funnel, and
a hub clamp within the cavity connected to the vertical pipe arrangement and the jumper pipe or the cap.

12. The subsea pipe connection system using a retrievable guide funnel of claim 11, wherein the upper guide portion further comprises:
an upper receiver section connected to the first funnel,
a second funnel connected to the upper receiver section, and
a lower receiver section connected to the second funnel.

13. The subsea pipe connection system using a retrievable guide funnel of claim 11, wherein the lower guide portion further comprises:
a lower guide funnel connected to the receiver section, and
a locking pin for securing the retrievable guide funnel.

14. The subsea pipe connection system using a retrievable guide funnel of claim 11, wherein the upper guide portion further comprises:
an upper receiver section connected to the first funnel,
a second funnel connected to the upper receiver section, and
a lower receiver section connected to the second funnel; and
wherein the lower guide portion further comprises:
a lower guide funnel connected to the receiver section, and
a locking pin for securing the retrievable guide funnel.

15. The subsea pipe connection system using a retrievable guide funnel of claim 14, wherein the hub clamp portion further comprises:
an ROV bucket for facilitating clamping.
